(19) United States
(12) Patent Application Publication
(10) Pub. No.: US 2008/0198191 A1
(43) Pub. Date: Aug. 21, 2008

(54) Liquid Jetting Device

(75) Inventors: Atsushi OSHIMA, Shiojiri-shi (JP); Kunio TABATA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/027,175

(22) Filed: Feb. 6, 2008

(30) Foreign Application Priority Data
Feb. 20, 2007 (JP) 2007-039050

(51) Int. Cl. B41J 29/38

(52) U.S. Cl. 347/10

(57) ABSTRACT

A liquid jetting device comprises plural nozzles provided at a liquid jetting head, actuators provided in correspondence with the respective nozzles, and a drive section that applies a drive signal to each of the actuators of the nozzles from which liquid is to be jetted, the liquid jetting device comprising: a drive waveform generator that generates a drive waveform signal as a reference of a signal that controls a drive state of each of the actuators; a modulator that performs the pulse modulation of the drive waveform signal which has been generated at the drive waveform generator; a digital power amplifier that power-amplifies a modulated signal which has been caused to undergo the pulse modulation at the modulator; a low pass filter (LPF) that smoothes the amplified digital signal which has been power-amplified at the digital power amplifier to deliver the smoothed modulated signal thus obtained, as a drive signal, to each of the actuators; and a pulse modulation reference signal generating section that outputs, to the modulator, a pulse modulation reference signal that prescribes a pulse modulation timing of the drive waveform signal by the modulator.

The entire disclosure of Japanese Patent Application No. 2007-039050 filed Feb. 20, 2007, is expressly incorporated by reference herein.

### BACKGROUND

1. Field of the Invention

The present invention relates to a liquid jetting device adapted for jetting, from plural nozzles, very small droplets of, e.g., liquids of plural colors to form micro particles (dots) onto a print medium to thereby describe a predetermined letter or image.

2. Description of the Related Art

Since ink-jet printers, which are one example of such liquid jetting devices, are generally inexpensive and make it possible to easily obtain color printed matter of high quality, such ink-jet printers have been widely popularized for not only office but also general user with popularization of personal computers and digital cameras, etc.

In such ink-jet printers, there is employed an approach to jet (inject), while relatively moving a print medium and a printing head (hereinafter referred to as ink-jet head as occasion may demand), liquid ink droplet from nozzles of the ink-jet head to form micro ink dots on the print medium to thereby describe a predetermined letter or image on the print medium to prepare a desired printed matter. A printer in which the ink-jet head is mounted on a movable body called carriage and is caused to be moved in a direction intersecting with a carrying direction of a print medium is generally called multi-pass type ink-jet printer. On the contrary, a printer in which an elongated ink jet-head (for which integration is not required) is disposed in a direction intersecting with a carrying direction of a print medium to permit printing by the so-called one pass is generally called “line head type ink-jet printer”. Particularly, in the line head type ink-jet printers, there is proposed a system of winding a carrying belt onto rollers to stretch the carrying belt therebetween to perform high speed printing while carrying a print medium by this carrying belt to thereby reduce the time required for printing per each print medium.

Meanwhile, ink-jet printers of this kind are required to have a higher gradation. The gradation refers to the state of densities of respective colors included in so-called pixels represented by ink dots. The size of ink dot corresponding to density of colors of each pixel refers to density gradient. The number of density gradients which can be represented by ink dot is called gradation number. The high gradation means that gradation number is large. In order to change density gradient, it is necessary to change a drive signal to an actuator provided at e.g., the ink-jet head. For example, in the case where the actuator is piezoelectric element, since when a voltage value applied to the piezoelectric element becomes large, displacement quantity (distortion) of the piezoelectric element (vibration plate when saying precisely) becomes large, this phenomenon is utilized to have ability to vary density gradient of ink dot.

In view of the above, in the JP-A-1998-81013, e.g., plural drive pulses having, e.g., different voltage crest values are connected in combination to generate a drive signal to output such a drive signal commonly to piezoelectric elements of nozzles of the same color provided at the ink-jet head to select, every nozzle, a drive pulse corresponding to density gradient of ink dot to be formed to deliver the selected drive pulse to the piezoelectric element of a corresponding nozzle to jet ink droplet to thereby attain a required density gradient of ink dot.

A method of generating a drive signal (or drive pulse) is described in FIG. 2 of the JP-A-2004-306434, for example. Namely, there is employed an approach to read, from a memory in which data of a drive signal is stored, the data to convert the data thus obtained into analog data at a D/A converter to deliver a drive signal to the ink-jet head through a current amplifier. As shown in FIG. 3 of the JP-A-2004-306434, the current amplifier is configured so as to include push-pull connected transistors, and serves to amplify a drive signal by the so-called linear drive. However, in the current amplifier of such configuration, linear drive itself of transistor has low efficiency. Moreover, not only it is necessary for countermeasure of heat produced from the transistor itself to use large-sized transistors, but also radiation plate for cooling transistors is required, etc. so that the circuit scale disadvantageously becomes large. Particularly, size of cooling radiation plate constitutes large obstacle in view of layout.

To overcome this drawback, it is conceivable to use digital power amplifier so called class D amplifier for amplifier output of drive signal. Since the digital power amplifier has excellent power amplification efficiency as compared to the analog power amplifier, it has small power loss and can sufficiently comply with fast rising or falling of a drive signal. In the case where a digital power amplifier is used to power-amplify a drive signal, there is employed, e.g., an approach to generate a drive waveform signal as a reference of a signal for controlling drive state of an actuator to perform pulse modulation of the drive waveform signal to power-amplify, by the digital power amplifier, a modulated signal which has been caused to undergo pulse modulation to smooth the amplified digital signal which has been power-amplified to deliver the smoothed modulated signal thus obtained to the actuator as a drive signal. For example, in a ink-jet printer described in JP-A-2005-329710, an outputted drive signal is fed back to perform feedback correction of a change of a voltage value of a drive signal due to change of power supply voltage.

### SUMMARY

However, in the case where a digital power amplifier is used to amplify a drive signal, pulse modulation of a drive waveform signal is required. In this case, e.g., in the case where pulse width modulation is used for pulse modulation, when phase of a triangular wave signal and phase of a drive waveform signal do not coincide with each other, pulse width of a modulated signal is changed. As a result, there is the possibility that reproduction of a drive signal to be generated may be lowered by such a change. In such a case, weight of ink droplet jetted from the nozzle of the ink-jet head is changed. This constitutes deterioration of print picture quality.

The present invention has been made by paying attention to the problems as described above, and its object is to provide a liquid jetting device capable of improving, in performing pulse modulation of a drive waveform signal to amplify the pulse-modulated signal by a digital power amplifier to output a drive signal, reproduction of the drive signal.

In order to solve the above-mentioned problems, a liquid jetting device of the first invention is a liquid jetting device comprising plural nozzles provided at a liquid jetting head, actuators provided in correspondence with the respective nozzles, and a drive section that applies a drive signal to each of the actuators of the nozzles from which liquid is to be jetted,

the liquid jetting device comprising: a drive waveform generator that generates a drive waveform signal as a reference of a signal that controls a drive state of each of the actuators; a modulator that performs a pulse modulation of the drive waveform signal which has been generated at the drive waveform generator; a digital power amplifier that power-amplifies a modulated signal which has been caused to undergo the pulse modulation at the modulator; a low pass filter (LPF) that smoothes the amplified digital signal which has been power-amplified at the digital power amplifier to deliver the smoothed modulated signal thus obtained, as a drive signal, to each of the actuators; and a pulse modulation reference signal generating section that outputs, to the modulator, a pulse modulation reference signal that prescribes a pulse modulation timing of the drive waveform signal by the modulator.

In accordance with the liquid jetting device according to the first invention, the pulse modulation reference signal that prescribes a pulse modulation timing of the drive waveform signal is outputted to the modulator, thereby making it possible to improve reproduction of the drive signal.

Moreover, the liquid jetting device of the second invention is such that, in the liquid jetting device of the first invention, in the case where the pulse modulation of the drive waveform signal by the modulator is a pulse width modulation, the pulse modulation reference signal generating section outputs, as a pulse modulation reference signal, a triangular wave phase reference signal that prescribes a phase of a triangular wave signal.

In accordance with the liquid jetting device of the second invention, in the case where the pulse modulation of the drive waveform signal is a pulse width modulation, a triangular wave phase reference signal that prescribes a phase of triangular wave signal is outputted as a pulse modulation reference signal, thereby making it possible to improve reproduction of the drive signal.

Further, the liquid jetting device of the third invention is such that, in the liquid jetting device of the first invention, in the case where the pulse modulation of the drive waveform signal by the modulator is a pulse density modulation, the pulse modulation reference signal generating section outputs, as a pulse modulation reference signal, a reset signal that resets a modulation sequence or a modulation parameter.

In accordance with the liquid jetting device of the third invention, in the case where the pulse modulation of the drive waveform signal is a pulse density modulation, a reset signal that resets a modulation sequence or a modulation parameter is outputted as a pulse modulation reference signal, thereby making it possible to improve a reproduction of the drive signal.

In addition, a liquid jetting device of the fourth invention is a liquid jetting device comprising plural nozzles provided at a liquid jetting head, actuators provided in correspondence with the respective nozzles, and a drive section that applies a drive signal to each of the actuators of the nozzles from which liquid is to be jetted,

the liquid jetting device comprising: a drive waveform generator that generates a drive waveform signal as a reference of a signal that controls a drive state of each of the actuators; a modulator that performs a pulse modulation of the drive waveform signal which has been generated at the drive waveform generator; a digital power amplifier that power-amplifies an amplified digital signal which has been caused to undergo a pulse modulation at the modulator; and a low pass filter (LPF) that smoothes the modulated signal which has been power-amplified at the digital power amplifier to deliver the smoothed modulated signal thus obtained, as a drive signal to each of the actuators,

wherein in the case where the pulse modulation of the drive waveform signal by the modulator is a pulse width modulation, a period of the drive waveform signal is caused to be integral multiple of an operation period in the modulator.

In accordance with the liquid jetting device of the fourth invention, in the case where pulse modulation of the drive waveform signal is pulse width modulation, a period of the drive waveform signal is caused to be integral multiple of an operation period in the modulator, thereby making it possible to improve reproduction of the drive signal.

### BRIEF DESCRIPTION OF THE DRAWINGS

FIGS. 1A and 1B are schematic diagrams showing outline of the configuration of a first embodiment of line head type ink-jet printer to which a head drive unit of a liquid jetting device of the present invention is applied, wherein FIG. 1A is a plan view and FIG. 1B is a front view;

FIG. 2 is a block diagram showing the configuration of a controller of the ink-jet printer of FIGS. 1A and 1B;

FIG. 3 is an explanatory view of a drive waveform signal generation;

FIG. 4 is an explanatory view of drive waveform signal connected in time series manner, or drive signal;

FIG. 5 is a block diagram of a selector unit for connecting a drive signal to an actuator;

FIG. 6 is a block diagram showing the configuration of a drive signal generating circuit;

FIGS. 7A and 7B are explanatory views of operation of a pulse width modulator;

FIG. 8 is an explanatory view of an operation of digital power amplifier of FIG. 6;

FIGS. 9A and 9B are explanatory views of a drive signal in the case where phase of a triangular wave signal is shifted in the pulse width modulator of FIGS. 7A and 7B;

FIG. 10 is an explanatory view in which drive signals of FIGS. 9A and 9B are caused to overlap with each other;

FIG. 11 is an explanatory view of an operation of pulse modulation reference signal including triangular wave phase reference signal;

FIG. 12 is a block diagram of a pulse density modulator used in a second embodiment of the liquid jetting device of the present invention;

FIG. 13 is a flowchart of a processing performed in the pulse density modulator of FIG. 12; and

FIG. 14 is a block diagram showing the configuration of a controller used in a third embodiment of the liquid jetting device of the present invention.

### DETAILED DESCRIPTION OF THE PREFERRED EMBODIMENTS

A first embodiment of an ink-jet printer to which the liquid jetting device of the present invention is applied will now be described with reference to the attached drawings.

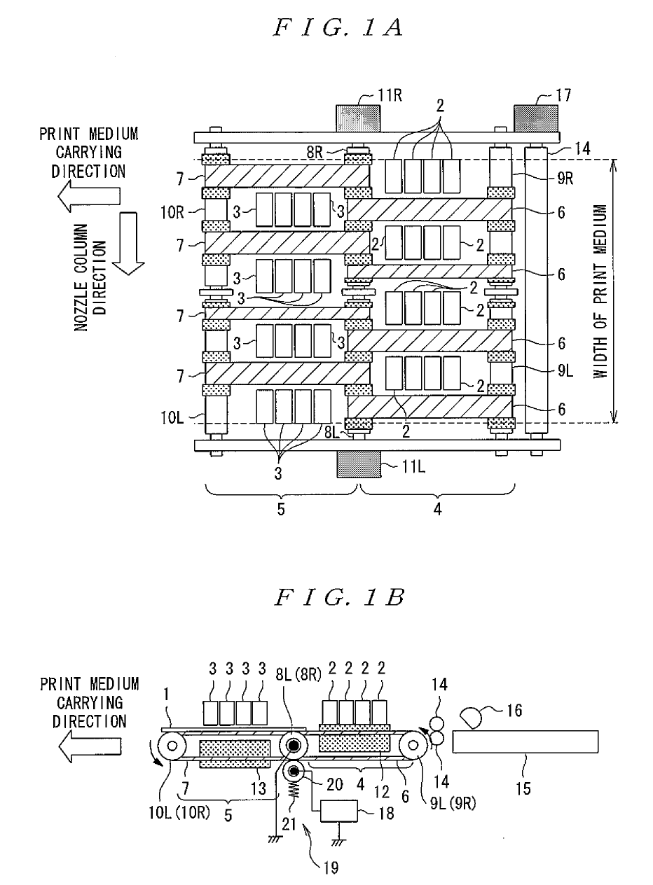

FIGS. 1A and 1B are schematic diagrams showing the outline of the configuration of the ink-jet printer of the present embodiment, wherein FIG. 1A is a plan view thereof and FIG. 1B is a front view thereof. In FIGS. 1A and 1B, there is employed a line head type ink-jet printer such that a print medium 1 is carried in a direction indicated by arrow of the figure from the right to the left of the figure, and printing operation is implemented within a printing region in the middle of carrying thereof. In this case, the ink-jet head of the present embodiment is not only at one part, but the ink-jet heads are disposed in a manner distributed into two parts.

The ink-jet printer includes a first ink-jet head 2 provided on the upstream side in the carrying direction of the print medium 1, a second ink-jet head 3 provided on the downstream side thereof, a first carrying unit 4 for carrying the print medium 1, which is provided at the lower part of the first ink-jet head 2, and a second carrying unit 5 provided at lower part of the second ink-jet head 3. The first carrying unit 4 is configured so as to include four first carrying belts 6 disposed with a predetermined interval in a direction intersecting with the carrying direction of the print medium 1 (hereinafter referred to as nozzle column direction as occasion may demand), and the second carrying unit 5 is configured so as to include four second carrying belts 7 disposed with a predetermined interval in a direction intersecting with the carrying direction of the print medium 1 thereof (nozzle column direction).

The four first carrying belts 6 and the four second carrying belts 7 are similarly disposed in a manner that they are alternately adjacent to each other. In the present embodiment, the two first and second carrying belts 6 and 7 on the right side in the nozzle column direction and the two first and second carrying belts 6 and 7 on the left side in the nozzle column direction are divided among these carrying belts 6, 7. Namely, a right side drive roller 8R is disposed at the part where two first and second carrying belts 6 and 7 on the right side in the nozzle column direction overlap with each other, a left side drive roller 8L is disposed at the part where two first and second carrying belts 6 and 7 on the left side in the nozzle column direction overlap with each other, a right side first driven roller 9R and a left side first driven roller 9L are disposed on the upstream side relative thereto, and a right side second driven roller 10R and a left side second driven roller 10L are disposed on the downstream side. These rollers are observed as if they are a series thereof, but are substantially divided at the central part of FIG. 1A. Further, the two nozzle column direction right side first carrying belts 6 are wound on the right side drive roller 8R and the right side first driven roller 9R. The two nozzle column direction left side first carrying belts 6 are wound on the left side drive roller 8L and the left side first driven roller 9L. The two nozzle column direction right side carrying belts 7 are wound onto the right side drive roller 8R and the right side second driven roller 10R. The two nozzle column direction left side second carrying belts 7 are wound onto the left side drive roller 8L and the left side second driven roller 10L. A right side electric motor 11R is connected to the right side drive roller 8R. A left side electric motor 11L is connected to the left side drive roller 8L. Accordingly, when the right side drive roller 8R is rotationally driven by the right side electric motor 11R, the first carrying unit 4 configured so as to include the two nozzle column direction right side first carrying belts 6 and the second carrying unit 5 similarly configured so as to include the two nozzle column direction right side second carrying belts 7 move in a manner synchronized with each other and at the same speed. When the left side drive roller 8L is rotationally driven by the left side electric motor 11L, the first carrying unit 4 configured so as to include the two nozzle column direction left side first carrying belts 6 and the second carrying unit 5 similarly configured so as to include the two nozzle column direction left side first carrying belts 7 move in a manner synchronized with each other and at the same speed. In this case, when rotational speed of the right side electric motor 11R and that of the left side electric motor 11L are caused to be different, it is possible to change nozzle column-direction left and right carrying speeds. In concrete terms, when the rotational speed of the right side electric motor 11R is caused to be larger than the rotational speed of the left side electric motor 11L, the carrying speed of the nozzle column direction right side is permitted to be larger than that of the nozzle column direction left side carrying speed. When the rotational speed of the left side electric motor 11L is caused to be larger than the rotational speed of the right side electric motor 11R, the nozzle column direction left side carrying speed is permitted to be larger than the nozzle column direction right side carrying speed.

The first ink-jet heads 2 and the second ink-jet heads 3 are disposed in the state positionally sifted in a carrying direction of the print medium 1 every respective colors of, e.g., yellow (Y), magenta (M), cyan (C) and black (K). Inks are supplied from ink tanks for respective colors (not shown) to the respective ink-jet heads 2, 3 through ink supply tubes. At the respective ink-jet heads 2, 3, there are formed plural nozzles in a direction intersecting with the carrying direction of the print medium 1 (i.e., nozzle column direction). Ink droplets of necessary quantities are simultaneously jetted from those nozzles toward necessary parts to thereby form and output very small ink dots on the print medium 1. By performing such an operation every respective colors, the print medium 1 carried by the first and second carrying units 4 and 5 is caused to be only passed once, thereby making it possible to perform printing operation by the so-called one pass. Namely, the regions where these ink-jet heads 2, 3 are disposed correspond to printing region.

As a method of jetting/outputting inks from respective nozzles of the ink-jet head, there are electrostatic system, piezo system and film boiling ink-jet system, etc. The electrostatic system is a system in which when a drive signal is applied to an electrostatic gap serving as an actuator, a vibration plate within a cavity is displaced so that pressure change takes place within the cavity, and ink droplets are thus jetted and outputted by such a pressure change. The piezo system is a system in which when a drive signal is applied to a piezoelectric element serving as an actuator, the vibration plate within the cavity is displaced so that pressure change takes place within the cavity, and ink droplets are thus jetted and outputted from nozzles by such a pressure change. The film boiling ink-jet system is a system in which a very small heater exists within a cavity, and inks are momentarily heated at 300° C. or more so that inks are in film boiling state and bubbles are thus produced so that ink droplets are jetted and outputted from the nozzles by such a pressure change. The present invention may be applied to either one of ink outputting methods. In particular, the present invention is suitable for piezoelectric element in which crest value or voltage increase/decrease gradient of a drive signal is adjusted to thereby have ability to adjust jet quantity of ink droplet.

The ink droplet jet nozzles of the first ink-jet head 2 are formed only between four first carrying belts 6 of the first carrying unit 4, and ink droplet jet nozzles of the second ink-jet head 3 are formed only between four carrying belts 7 of the second carrying unit 5. The reason why such arrangement is employed is to perform cleaning of respective ink-jet heads 2, 3 by cleaning unit which will be described later. However, when such arrangement is employed, it is impossible to perform the entire surface printing by one pass even with only either one of ink-jet heads. For this reason, in order to compensate the part in which printing cannot be performed each other, the first and second ink-jet heads 2 and 3 are disposed in the state positionally shifted in the carrying direction of the print medium 1.

The member disposed below the first ink-jet head 2 is a first cleaning cap 12 for performing cleaning of the first ink-jet head 2, and the member disposed below the second ink-jet head 3 is a second cleaning cap 13 for performing cleaning of the second ink-jet head 3. The respective cleaning caps 12, 13 are both formed so as to have dimensions such that they can be passed between four first carrying belts 6 of the first carrying unit 4 and between four second carrying belts 7 of the second carrying unit 5. Each of these cleaning caps 12, 13 is configured so as to include, e.g., a rectangular parallelepiped cap body including bottom which covers the nozzles formed on the lower surfaces of each of the ink-jet heads 2, 3, i.e., nozzle surface and can be closely in contact with the nozzle surface, an ink absorbing body disposed on the bottom part thereof, a tube pump connected to the bottom part of the cap body, and a vertically moving unit for vertically moving the cap body. Thus, the cap body is elevated by the vertically moving unit so that it is closely in contact with nozzle surface of each of the ink-jet heads 2, 3. When the inside of the cap body is caused to be negative pressure by the tube pump in that state, ink droplets or bubbles are sunk or drawn out from nozzles opened at the nozzle surfaces of the ink-jet heads 2, 3. Thus, cleaning of the ink-jet heads 2, 3 can be performed. When cleaning is completed, the cleaning caps 12, 13 are lowered.

On the upstream side of the first driven rollers 9R, 9L, there are provided two paired gate rollers 14 for adjusting feed timing of print medium 1 supplied from the paper feed unit 15, and for correcting skew of the print medium 1. The skew is twist of the print medium 1 with respect to the carrying direction. Moreover, at the upper part of the paper feed unit 15, there is provided a pick-up roller 16 for supplying the print medium 1. In the figure, reference numeral 17 denotes a gate roller motor for driving the gate roller 14.

At the lower part of drive rollers 8R, 8L, there is disposed a belt electrifying unit 19. This belt electrifying unit 19 is configured so as to include an electrifying roller 20 which is in contact with the first and second carrying belts 6 and 7 with the drive roller 8R, 8L being held therebetween, a spring 21 for pressing the electrifying roller 20 onto the first and second carrying belts 6 and 7, and a power source 18 for giving charges onto the electrifying roller 20; and serves to give charges onto the first and second carrying belts 6 and 7 from the electrifying roller 20. Since these belts and the like are generally configured so as to include high resistor or insulator, when electrically charged by the belt electrifying unit 19, charges applied on the surface thereof produce dielectric polarization in the print medium 1 similarly configured so as to include high resistor or insulator to have ability to absorb the print medium 1 onto the belt by electrostatic force produced between charges produced by the dielectric polarization and charges of the belt surface. In this case, as the belt electrifying unit 19, there may be employed so-called corotron to fall charges.

Accordingly, in accordance with this ink-jet printer, the surfaces of the first and second carrying belts 6 and 7 are electrically charged by the belt electrifying unit 19 to deliver print medium 1 from the gate roller 14 in that state. When the print medium 1 is pressed onto the first carrying belt 6 by paper pressing roller configured so as to include spur or roller (not shown), the print medium 1 is absorbed onto the surface of the first carrying belt 6 by action of the previously described dielectric polarization. When drive rollers 8R, 8L are rotationally driven by electric motors 11R, 11L in this state, its rotational drive force is transmitted to the first driven rollers 9R, 9L through the first carrying belt 6.

The first carrying belt 6 is moved toward the downstream side in the carrying direction in the state where the print medium 1 is absorbed in this way to move the print medium 1 toward the lower part of the first ink-jet head 2 to jet ink droplet from nozzles formed at the first ink-jet head 2 to perform printing operation. When printing operation by the first ink-jet head 2 is completed, the print medium 1 is moved toward the downstream side in the carrying direction to ride and transfer the print medium 1 onto the second carrying belt 7 of the second carrying unit 5. As previously described, since the surface of the second carrying belt 7 is also electrically charged by the belt electrifying unit 19, the print medium 1 is absorbed onto the surface of the second carrying belt 7 by the action of the previously dielectric polarization.

In this state, the second carrying belt 7 is moved toward the downstream side in the carrying direction to move the print medium 1 toward the lower part of the second ink-jet head 3 to jet ink droplet from nozzles formed at the second ink-jet head 3 to perform printing operation. After printing operation by the second ink-jet head 3 is completed, the print medium 1 is further moved toward the downstream side in the carrying direction to eject the print medium 1 toward an ejecting unit while separating it from the surface of the second carrying belt 7 by separator (not shown).

Moreover, when cleaning of the first and second ink-jet heads 2, 3 is required, the first and second cleaning caps 12, 13 are elevated as previously described to allow the cap body to be closely in contact with each of nozzle surfaces of the first and second ink-jet heads 2, 3 to allow the inside of the cap body to be negative pressure in that state to thereby absorb ink droplets or bubbles from nozzles of the first and second ink-jet heads 2, 3 thereafter to lower the first and second cleaning caps 12, 13.

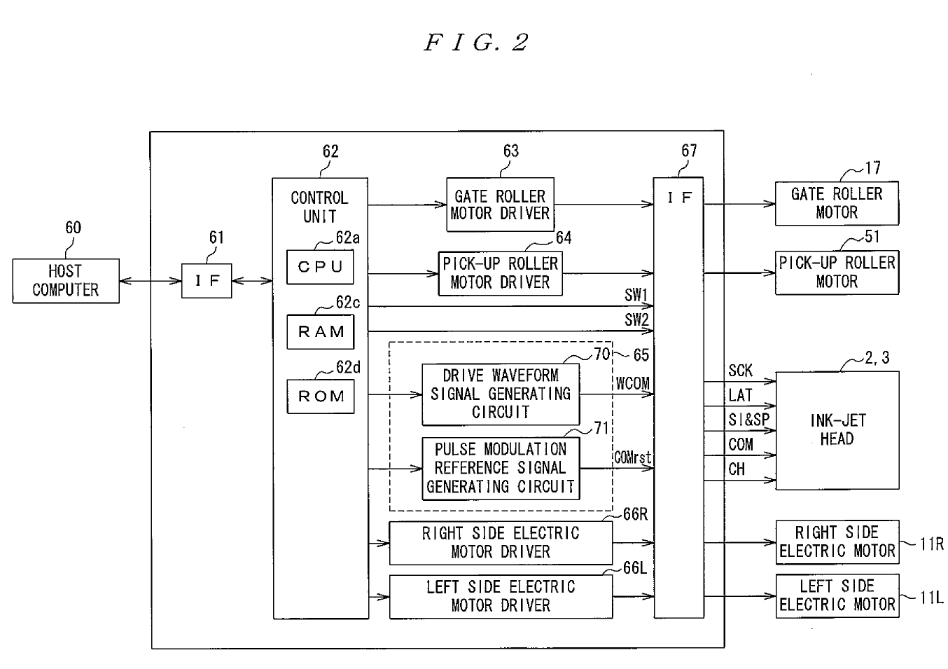

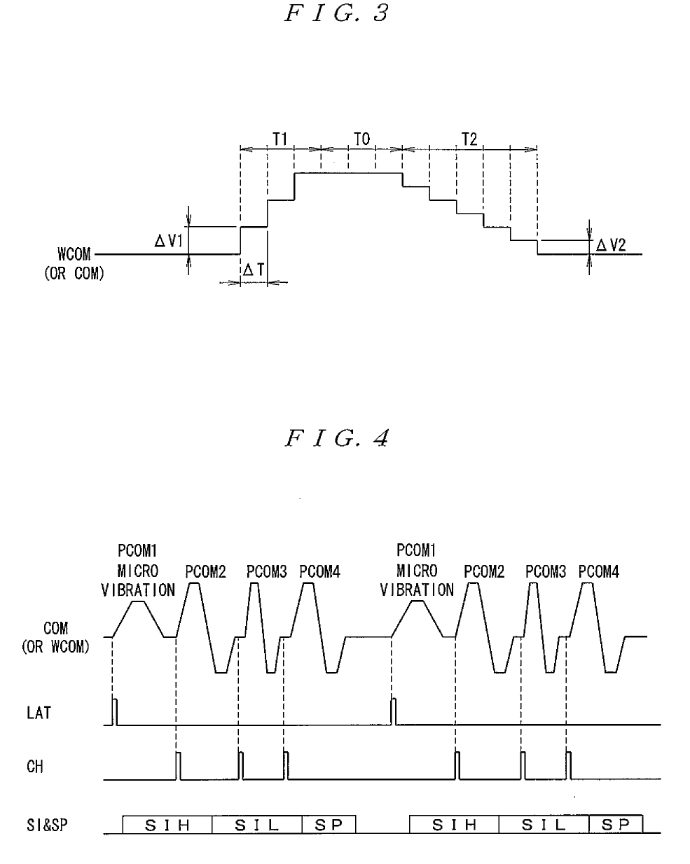

Within the ink-jet printer, there is provided a controller for controlling own equipment. For example, as shown in FIG. 2, this controller serves to control a printing apparatus or a paper feeder, etc. on the basis of print data inputted from a host computer 60, e.g., personal computer, or digital camera, etc. to thereby perform printing processing onto a print medium. The controller includes an input interface 61 for receiving print data inputted from the host computer 60, a control unit 62 configured so as to include, e.g., microcomputer, which executes print processing on the basis of print data inputted from the input interface 61, a gate roller motor driver 63 for driving and controlling a gate roller motor 17, a pick-up roller motor driver 64 serving to drive and control a pick-up roller motor 51 for driving the pick-up roller 16, a head driver 65 for driving and controlling the ink-jet heads 2, 3, a right side electric motor driver 66R for driving and controlling right side electric motor 11R, a left side electric motor driver 66L for driving and controlling left side electric motor 11L, and an interface 67 for converting output signals of the respective drivers 63 to 65, 66R, 66L into drive signals used in the external gate roller motor 17, the pick-up roller motor 51, the ink-jet heads 2, 3, the right side electric motor 11R, and the left side electric motor 11L to output them.

The control unit 62 comprises a CPU (Central Processing Unit) 62a for executing various processing such as print processing, etc., a RAM (Random Access Memory) 62c for temporarily storing print data inputted through an input interface 61 or various data in executing the print data printing processing, etc., or for temporarily developing application program such as print processing, etc., and a RON (Read-Only Memory) 62d configured so as to include non-volatile semiconductor memory for storing control program, etc. executed at the CPU 62a, etc. When this control unit 62 acquires print data (image data) from the host computer 60 through the interface 61, the CPU 62a executes a predetermined processing with respect to this print data to output print data (drive signal select data SI & SP) indicating a nozzle from which ink droplets are jetted, or jet quantity of ink droplet to output control signals to respective drivers 63 to 65, 66R, 66L on the basis of the print data and input data from various sensors. When the control signals are outputted from the respective drivers 63 to 65, 66R, 66L, these outputs are converted into drive signals at the interface 67. As a result, the actuators corresponding to plural nozzles of the ink-jet heads, the gate roller motor 17, the pick-up roller motor 51, the right side electric motor 11R and the left side electric motor 11L respectively become operative. Thus, feeding and carrying of print medium 1, attitude control of print medium 1 and print processing onto the print medium 1 are executed.

The head driver 65 comprises a drive waveform signal generating circuit 70 for forming a drive waveform signal WCOM, and a pulse modulation reference signal generating circuit 71 for outputting a pulse modulation reference signal COMrst. For example, as shown in FIG. 3, the drive waveform signal generating circuit 70 serves to add drive waveform signals WCOM by waveform data +ΔV1 at a timing of rising of a clock signal for a time period of time width T1 from the state where the drive waveform signal WCOM is raised up to intermediate potential (offset) to subsequently hold the drive waveform signal WCOM at a predetermined value (waveform data 0) for a time width T0 to subsequently subtract drive waveform signals WCOM by waveform data −ΔV2 at a timing of rising of the clock signal for a time period of time width T2. The drive waveform signal WCOM generated in this way is pulse-modulated, for example, at interface 67. The amplified digital signal thus obtained is power-amplified. The signal thus obtained is delivered to ink-jet heads 2, 3 as drive signal CON to thereby have ability to drive the actuators such as piezoelectric elements, etc. provided every respective nozzles. Thus, ink droplets can be jetted from respective nozzles. Moreover, a pulse modulation reference signal COMrst outputted from the pulse modulation reference signal generating circuit 71 serves to prescribe pulse modulation timing of drive waveform signal. The detail thereof will be described later.

The rising part of the drive signal COM corresponds to a stage to enlarge volume of a cavity (pressure chamber) communicating with the nozzle to draw or pull ink thereinto (when jet surface of ink is taken into consideration, it can be said that meniscus is drawn in); and the falling part of the drive signal COM is a stage to contract volume of the cavity to thrust ink (when jet surface of ink is taken into consideration, it can be said that meniscus is drawn out). As the result of thrust of ink, ink droplets are jetted from the nozzle. In this respect, as easily estimated from the previously described fact, the waveform of drive signal COM or drive waveform signal WCOM can be adjusted by waveform data 0, +ΔV1, −ΔV2, +ΔV3 written into addresses A0 to A3, first clock signal ACLK, and second clock signal BCLK.

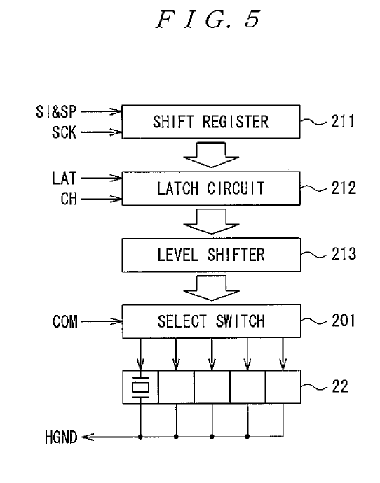

By variously changing voltage increase/decrease gradient or crest value of a drive signal COM constituted by voltage trapezoidal wave, it is possible to change draw-in quantity or draw-in rate of ink, and thrust quantity or thrust rate of ink. Thus, jet quantity of ink droplet is changed, thus making it possible to obtain ink dots different in size. Accordingly, as shown in FIG. 4, for example, even in the case where plural drive signals COM are connected in a time series manner, a single drive signal COM is selected from them to deliver the selected drive signal COM thus obtained to the actuator 22 such as piezoelectric element, etc. to jet ink droplet, or to select plural drive signals COM to deliver the selected signals to the actuators 22 such as piezoelectric element, etc. to jet ink droplet plural times to thereby have ability to obtain various of sizes ink dots. Namely, when plural ink droplets are hit or shot onto the same position before ink is dried, there results the phenomenon that large ink droplet is substantially jetted. Thus, size of the ink dot can be increased. By such combination of technologies, it becomes possible to realize multi-tone. In this case, the drive signal at the left end of FIG. 4 only draws ink thereinto, but does not thrust it. This phenomenon is called micro vibration, and is used for suppressing or preventing, e.g., drying of nozzle without jetting ink droplet.

As the result of the above fact, the ink-jet heads 2, 3 are supplied with drive signal select data SI & SP for selecting a nozzle subject to jetting on the basis of drive signal COM generated at the interface 67 and print data, and for determining connection timing to drive signal COM for actuator such as piezoelectric element, etc.; a latch signal LAT and a channel signal CH which are adapted for connecting, after nozzle select data is inputted to all nozzles, drive signal COM and actuators of the ink-jet heads 2, 3 on the basis of the drive signal select data SI & SP, and a clock signal SCK for transmitting, as a serial signal, the drive signal select data SI & SP to the ink-jet heads 2, 3. It is to be noted that in the case where plural drive signals COM are connected in time series manner and are outputted, single drive signal COM will be described as drive pulse PCOM, and the signal entirety in which drive pulses PCOM are connected in a time series manner will be described as drive signal COM, hereinafter.

The configuration for connecting the drive signal COM outputted from the drive circuit and an actuator such as piezoelectric element, etc. will now be described. FIG. 5 is a block diagram of a selector unit for connecting the drive signal COM and the actuator such as piezoelectric element, etc. This selector unit is configured so as to include a shift register 211 serving to hold drive signal select data SI & SP for designating an actuator such as piezoelectric element, etc. corresponding to a nozzle from which ink droplet is to be jetted, a latch circuit 212 for temporarily storing data of the shift register 211, a level shifter 213 for performing level conversion of an output of the latch circuit 212, and a select switch 201 for connecting a drive signal COM to an actuator 22 such as piezoelectric element, etc. in accordance with an output of the level shifter.

The shift register 211 is sequentially supplied with drive signal select data SI & SP, and is such that the memory area sequentially shifts from the first stage to the succeeding stage in accordance with an input pulse of the clock signal SCK. After drive signal select data SI & SP corresponding to the number of nozzles are stored into the shift register 211, the latch circuit 212 latches respective output signals of the shift register 211 by an inputted latch signal LAT. Each signal stored in the latch circuit 212 is converted into a voltage level at which the select switch 201 of the succeeding stage can be turned ON/OFF by the level shifter 213. This is because the drive signal COM is a high voltage as compared to an output voltage of the latch circuit 212, and the operational voltage range of the select switch 201 is set to a high value in correspondence therewith. Accordingly, the actuator such as piezoelectric element, etc. in which select switch 201 is closed by level shifter 213 is connected a drive signal COM at connection timing of the drive signal select data SI & SP. Moreover, after the signal select data SI & SP of the shift register 211 are stored in the latch circuit 212, the next print information is inputted to the shift register 211 to sequentially update storage data of the latch circuit 212 in correspondence with jet timing of ink droplet. Reference numeral HGND in the figure designates a ground terminal of actuator such as piezoelectric element, etc. Moreover, in accordance with this select switch 201, also after the actuator such as piezoelectric element, etc. is cut off from the drive signal COM, an input voltage for the actuator 22 is maintained at a voltage immediately before cutting off.

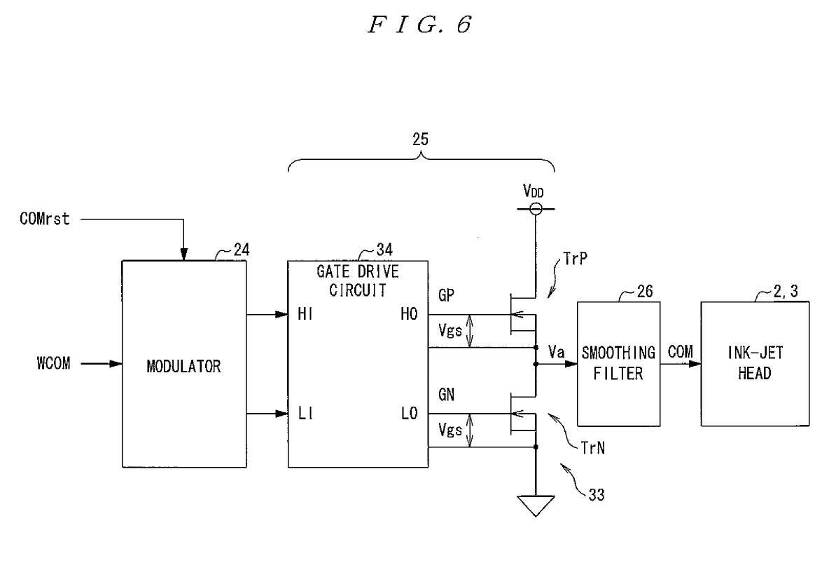

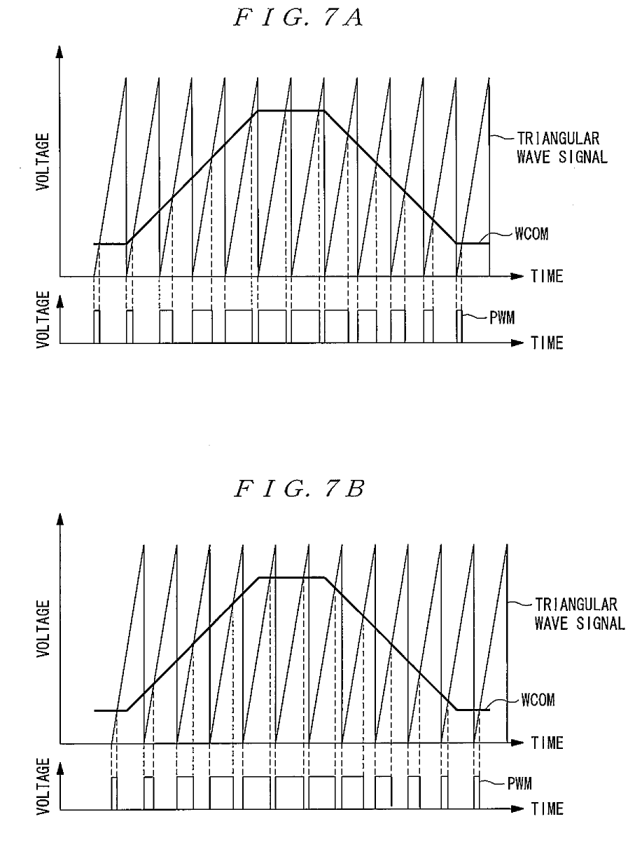

A drive signal generating circuit constructed in the interface 67, which is adapted for pulse-modulating drive waveform signal WCOM to further power-amplify the modulated signal thus obtained to generate and output a drive signal COM, will now be described. This drive signal generating circuit is configured, as shown in FIG. 6, so as to include a modulator 24 for performing pulse modulation of a drive waveform signal WCOM generated at drive waveform signal generating circuit 70, a digital power amplifier, which is so-called class D amplifier 25, for power-amplifying a modulated signal which has been caused to undergo pulse modulation at the modulator 24, and a low pass filter (LPF) 26 for smoothing the amplified digital signal which has been power-amplified at the digital power amplifier 25. As the modulator 24 for performing pulse modulation of drive waveform signal WCOM, there was used typical pulse width modulator (PWM). This pulse width modulator 24 is configured so as to include a well known triangular wave oscillator, and a comparator for comparing a triangular wave signal outputted from the triangular wave oscillator and drive waveform signal WCOM. In accordance with this pulse width modulator 24, as shown in FIGS. 7A and 7B, for example, there is outputted a modulated signal, so-called PWM signal in which when drive waveform signal WCOM is triangular wave signal or more, it is caused to be at Hi level, while when drive waveform signal WCOM is less than triangular wave signal, it is caused to be at Lo level. In the present embodiment, phase of triangular wave signal can be prescribed by a pulse modulation reference signal, i.e., a triangular wave phase reference signal in a practical sense, which is outputted from the pulse modulation reference signal generating circuit 71.

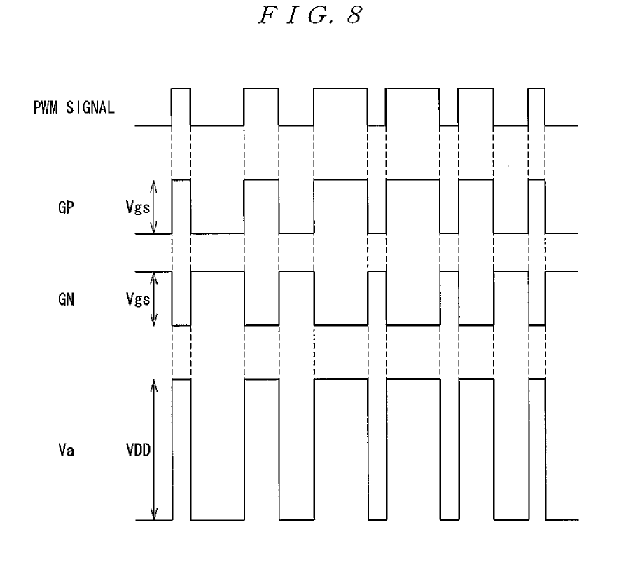

The action of the digital power amplifier, so-called class D amplifier 25 will now be described. This digital power amplifier 25 is configured so as to include a half-bridge driver stage 33 including two MOSFETs TrP, TrN for substantially amplifying power, and a gate drive circuit 34 for adjusting signals between gate and source GP, GN of those MOSFETs TrP, TrN. Specifically, the half-bridge driver stage 33 is such that the High side MOSFET TrP and the Low side MOSFET TrN are combined so that they are of the push-pull type. Among them, when the gate-source signal of the High side MOSFET TrP is GP, the gate-source signal of the Low side MOSFET TrN is GN, and an output of the half-bridge driver stage 33 is Va, how those FETs change in accordance with a modulated signal (PWM) is shown in FIG. 8. It is here assumed that each of voltage values Vgs of gate-source signals GP, GN of respective MOSFETs TrP, TrN is a voltage value sufficient to allow those MOSFETs TrP, TrN to be turned ON.

When the modulated signal is at Hi level, the gate-source signal GP of the High side MOSFET TrP is caused to be at Hi level, and the gate-source signal GN of the Low side MOSFET TrN is caused to be at Lo level. Accordingly, the High side MOSFET TrP is placed in ON state, and the Low side MOSFET TrN is placed in OFF state. As a result, an output Va of the half-bridge driver stage 33 results in supply power VDD. On the other hand, when a modulated signal is at Lo level, the gate-source signal GP of the High side MOSFET TrP is caused to be at Lo level, and the gate-source signal GN of the Low side MOSFET TrN is caused to be at Hi level. Accordingly, the High side MOSFET TrP is placed in OFF state, and the Low side MOSFET TrN is placed in ON state. As a result, an output Va of the half-bridge driver stage 33 results in 0.

An output Va of the half-bridge driver stage 33 of this digital power amplifier circuit 25 is delivered to select switch 201 through a low pass filter (LPF) 26 as a drive signal COM. The low pass filter (LPF) 26 is constituted by, e.g., Low-Pass (Low Band Pass) filter including one resistance R, one inductance L and one electro static capacitance C in combination. The low pass filter (LPF) 26 constituted by the low-pass filter is designed so as to sufficiently attenuate high frequency component of output Va of the half-bridge driver stage 33 of the digital power amplifier circuit 25, i.e., the amplified digital signal component, and so as not to attenuate drive signal component COM (or drive waveform component WCOM).

In the case where the MOSFETs TrP, TrN of the digital power amplifier 25 are so-called digitally driven as previously described, since the MOSFET functions as a switch element, a current flows in a MOSFET in the ON state. However, resistance value between drain and source is very small, and loss hardly takes place. Moreover, since no current flows in the MOSFET in the OFF state, no loss takes place. Accordingly, loss of this digital power amplifier 25 is extremely small, and small-sized MOSFET can be thus used. In addition, cooling section such as cooling radiation plate, etc. is also unnecessary. In this respect, the efficiency at the time of linearly driving transistor is about 30%, whereas the efficiency of the digital power amplifier is 90% or more. In addition, since the cooling radiation plate for transistor is required to have dimensions of about 60 mm×60 mm with respect to one transistor, when such cooling radiation plate becomes unnecessary, this is extremely advantageous from a viewpoint of actual layout.

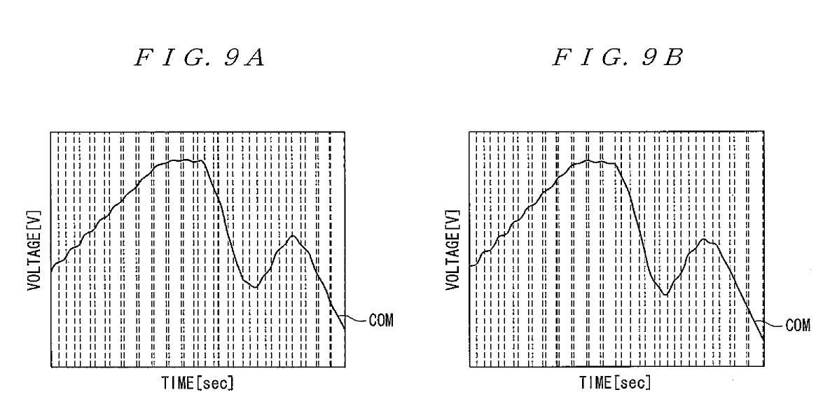

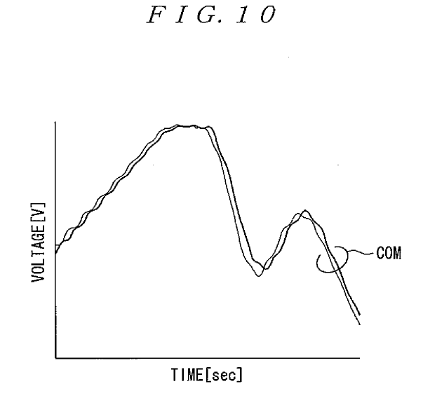

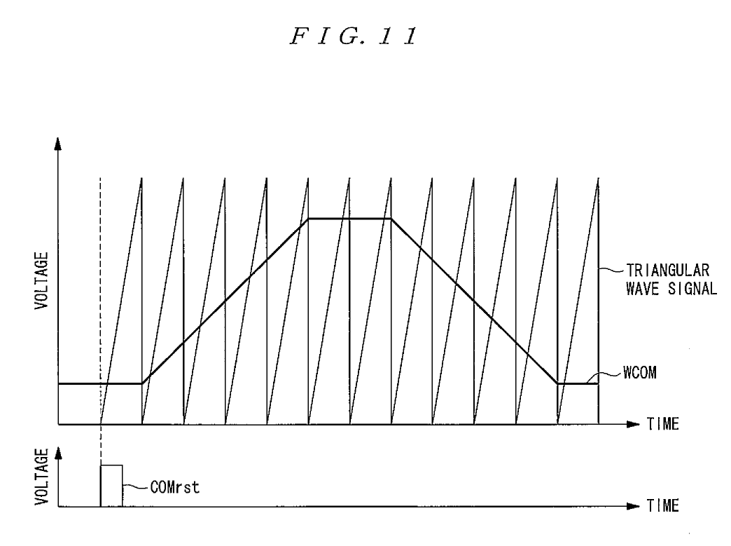

As previously described, FIGS. 7A and 7B show the action of pulse width modulation at the pulse width modulator 24 of the present embodiment. In this case, there is the possibility that phase of a triangular wave signal may be shifted depending upon circumstances as indicated by FIGS. 7A and 7B. When phase of the triangular wave is shifted, shift may take place at a comparison timing with respect to the drive waveform signal WCOM. As a result, as shown in FIGS. 9A, 9B and 10, shift takes place in a drive signal COM, i.e., reproduction of drive signal COM is lowered. When reproduction of drive signal is lowered, weight of ink droplets jetted from nozzles of the ink-jet heads 2, 3 are changed as a matter of course. This constitutes a cause to deteriorate print picture quality.

In view of the above, in the present embodiment, as shown in FIG. 11, there is employed a configuration to start output of a triangular wave signal in correspondence with rising of pulse modulation reference signal COMrst including triangular wave phase reference signal. As a result, the pulse modulation reference signal including triangular wave phase reference signal is synchronized with drive waveform signal WCOM. As a result, phase shift between drive waveform signal WCOM and triangular wave signal is eliminated so that reproduction of drive signal COM is improved. Thus, it is possible to ensure weight of ink droplet jetted from each of nozzles of the ink-jet heads 2, 3 thus to prevent deterioration in print picture quality.

As stated above, in accordance with the ink-jet printer of the present embodiment, in the ink-jet printer comprising plural nozzles provided at the ink-jet heads 2, 3, actuators provided in correspondence with respective nozzles, and a drive section for applying a drive signal COM to the actuator of a nozzle from which ink droplet is to be jetted; in generating drive waveform signal WCOM as a reference of a signal for controlling drive state of the actuator to pulse-modulate the drive waveform signal WCOM to power-amplify a modulated signal which has been pulse-modulated to smooth the amplified digital signal which has been power-amplified to deliver the smoothed modulated signal to the actuator as a drive signal COM, there is employed a configuration to output, to the modulator, pulse modulation reference signal COMrst for prescribing pulse modulation timing of the drive waveform signal WCOM. For this reason, it is possible to improve reproduction of drive signal COM.

In addition, in the case where pulse modulation of the drive waveform signal WCOM is pulse width modulation, since there is employed a configuration to output, as pulse modulation reference signal COMrst, a triangular wave phase reference signal for prescribing phase of a triangular wave signal, it is easy to carry out the invention.

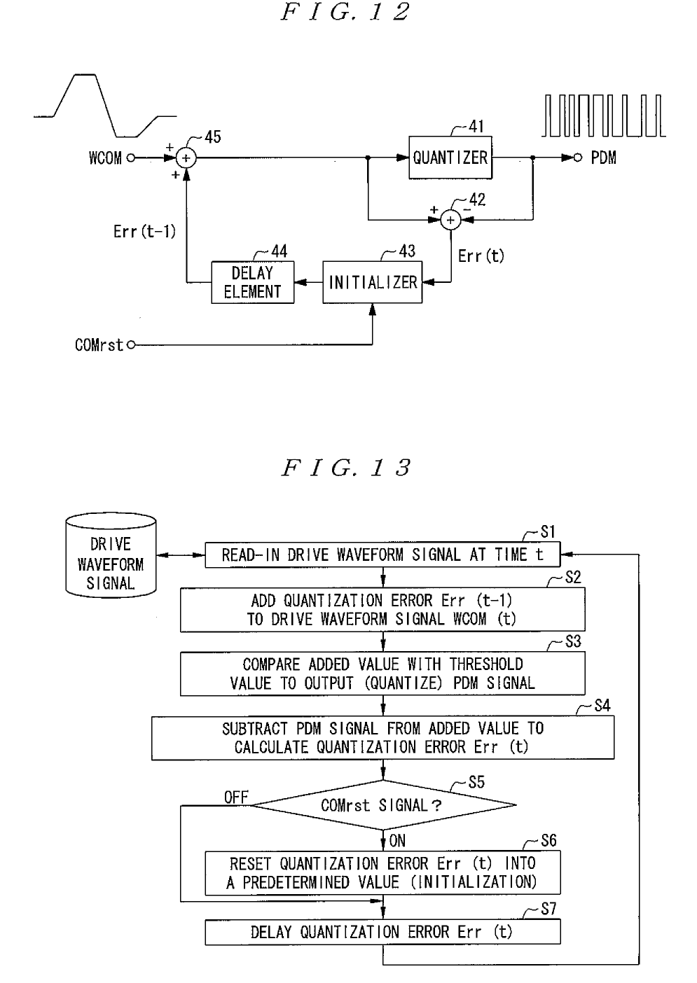

The case where pulse density modulator is used in place of the pulse width modulator of the first embodiment will now be described as the second embodiment of an ink-jet printer to which the liquid jetting device of the present invention is applied. As well known, the pulse density modulator quantizes (binarizes) an analog signal at a quantizer to perform ON/OFF control of pulses corresponding to clock length on the basis of the result. FIG. 12 shows a block diagram of a pulse density modulator for performing PDM (Pulse Density Modulation) of drive waveform signal WCOM in the present embodiment. In the fundamental pulse density modulator, drive waveform signal WCOM is quantized (binarized) at a quantizer 41 to extract its input/output error at an adding/subtracting element 42 as quantization error Err(t) to delay its quantization error Err(t) at a delay element 44 to add delayed quantization error Err(t-1) to drive waveform signal WCOM at an adder 45.

However, in this existing pulse density modulator, since calculated quantization error Err(t) always changes, every time drive waveform signal WCOM is inputted to a pulse density modulator, quantization error Err(t) varies. For this reason, every time actuator such as piezoelectric element, etc. is driven, modulated signals obtained by allowing drive waveform signal WCOM to undergo pulse density modulation PDM would be different from each other. In view of the above, in the present embodiment, an initializer 43 is inserted between adding/subtracting element 42 and delay element 44 to output a pulse modulation reference signal COMrst including a reset signal in synchronism with the drive waveform signal WCOM. When the pulse modulation reference signal COMrst including the reset signal is inputted, quantization error Err(t) is initialized into a predetermined value at the initializer 43 to reset modulation sequence or modulation parameter.

FIG. 13 shows, by flowchart, the function of this pulse density modulator. In this computational processing, in step S1, drive waveform signal WCOM (t) at time t is first read in.

Next, processing moves to step S2 to add delayed quantization error Err(t-1) to the drive waveform signal WCOM (t) which has been read in.

Next, processing moves to step S3 to compare the drive waveform signal WCOM (t) to which the delayed quantization error Err(t-1) has been added with a threshold value to output a pulse density modulated signal PDM.

Next, processing moves to step S4 to subtract the pulse density modulated signal PDM from the drive waveform signal WCOM (t) to which the delayed quantization error Err(t-1) has been added to calculate a quantization error Err(t).

Next, processing moves to step S5 to determine whether or not pulse modulation reference signal COMrst including reset signal is inputted. As a result, when the pulse modulation reference signal COMrst including reset signal is inputted, processing moves to step S6. When otherwise, processing moves to step S7.

In step S6, the quantization error Err(t) is initialized into a predetermined value thereafter to reset modulation sequence or modulation parameter to move to step S7.

In step S7, the quantization error Err(t) is delayed to calculate delayed quantization error Err (t-1) thereafter to move to step S1.

In accordance with this computational processing, when the pulse modulation reference signal COMrst including reset signal is inputted, the quantization error Err(t) is initialized into a predetermined value so that the modulation sequence or the modulation parameter is reset. For this reason, delayed quantization error Err (t-1) added to the drive waveform signal WCOM at the time of starting of pulse density modulation results in a predetermined value. Thus, reproduction of drive signal COM which has been pulse-density modulated and has been power-amplified can be improved.

As stated above, in accordance with the ink-jet printer of the present embodiment, in the case where pulse modulation of the drive waveform signal WCOM is pulse density modulation, there is employed the configuration to output, as pulse modulation reference signal COMrst, a reset signal for resetting modulation sequence or modulation parameter. For this reason, facilitation to carry out the invention is obtained in addition to the advantage of the first embodiment.

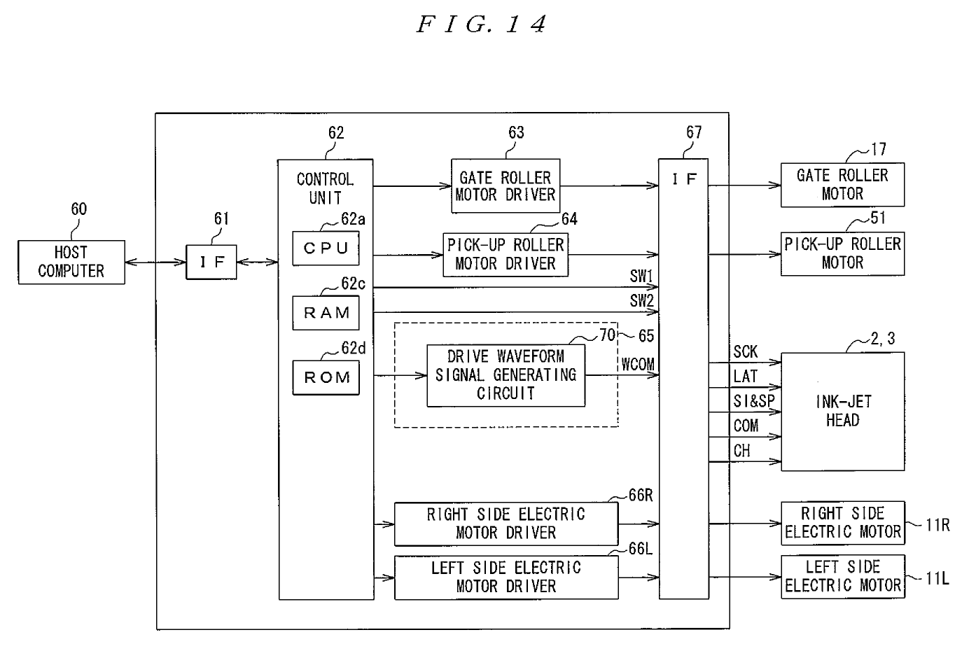

A third embodiment of an ink-jet printer of the present invention will now be described with reference to FIG. 14. In the present embodiment, the pulse modulation reference signal generating circuit is omitted from the block diagram of the controller of FIG. 2 of the first embodiment. In addition to the above, in the present embodiment, a period of the drive waveform signal WCOM is caused to be integral multiple of an operation period (carrier period) in the pulse width modulator 24 of the first embodiment. As stated above, the period of the drive waveform signal WCOM is caused to be integral multiple of operation period in the pulse width modulator 24, thereby making it possible to reproduce, as drive waveform signal WCOM, a drive signal COM which has been pulse-width modulated and has been power-amplified.

As stated above, in accordance with the ink-jet printer of the present embodiment, there is provided an ink-jet printer comprising plural nozzles provided at the ink-jet heads 2, 3, actuators provided in correspondence with respective nozzles, and a drive section for applying a drive signal COM to the actuator of the nozzle from which ink droplet is to be jetted, wherein, in generating a drive waveform signal WCOM as a reference of a signal for controlling drive state of the actuator to perform pulse modulation of the drive waveform signal WCOM to power-amplify a modulated signal to smooth the power-amplified modulated signal to deliver the smoothed modulated signal to the actuator as a drive signal COM, in the case where pulse modulation of the drive waveform is pulse width modulation, the period of the drive waveform signal WCOM is caused to be integral multiple of an operation period in the modulator, thereby making it possible to improve reproduction of the drive signal COM.

It is to be noted that only the example where the liquid jetting device of the present invention is applied to the so-called line head type ink-jet printer has been described in detail in the above-mentioned embodiments, the liquid jetting device of the present invention may be applied to ink-jet printers of all types including the multi-pass type printer.

Moreover, while the liquid jetting device of the present invention is embodied as the ink-jet type printing apparatus in the above-mentioned embodiments, the present invention is not limited to such implementations, but may be also embodied as a liquid jetting device adapted for injecting or jetting other liquids except for ink (including liquid like material containing functional material particles dispersed therein, or fluid-like material including gel in addition to liquid), or fluid except for liquid (solid permitted to flow as fluid and to be injected, etc.). For example, the present invention may be applied to a liquid like material jetting apparatus adapted for jetting liquid like material including material such as electrode material or color material in a distributed or dissolved form, which is used for manufacturing of, e.g., liquid crystal display, EL (Electroluminescence) display, surface light emitting display or color filter, etc., a liquid jetting device adapted for injecting bio-organic material used in biochip manufacturing, and a liquid jetting device adapted for jetting liquid used as precise pipet and serving as sample. Further, the present invention may be applied to a liquid jetting device adapted for jetting lubricating oil in a pinpoint manner onto precision instrument such as watch or camera, etc., a liquid jetting device adapted for jetting, onto a substrate, transparent resin solution such as ultraviolet hardening resin for forming micro semi-spherical lens (optical lens), etc. used in optical communication device, etc., a liquid jetting device for jetting etchant such as acid or alkali, etc., in order to etch substrate, a fluid like material jetting device adapted for jetting gel, and a fluid jet type recording apparatus adapted for jetting solid in which powder such as toner, etc. is taken as an example. In addition, the present invention may be applied to any one kind of jetting devices.

What is claimed is:

1. A liquid jetting device comprising plural nozzles provided at a liquid jetting head, actuators provided in correspondence with the respective nozzles, and a drive section that applies a drive signal to each of the actuators of the nozzles from which liquid is to be jetted,
the liquid jetting device comprising:
a drive waveform generator that generates a drive waveform signal as a reference of a signal that controls a drive state of each of the actuators;
a modulator that performs a pulse modulation of the drive waveform signal which has been generated at the drive waveform generator;
a digital power amplifier that power-amplifies for power-amplifying a modulated signal which has been caused to undergo the pulse modulation at the modulator;
a low pass filter (LPF) that smoothes the amplified digital signal which has been power-amplified at the digital power amplifier to deliver the smoothed modulated signal thus obtained, as a drive signal, to each of the actuators; and
a pulse modulation reference signal generating section that outputs, to the modulator, a pulse modulation reference signal that prescribes a pulse modulation timing of the drive waveform signal by the modulator.

2. The liquid jetting device according to claim 1,
wherein in the case where the pulse modulation of the drive waveform signal by the modulator is a pulse width modulation, the pulse modulation reference signal generating section outputs, as a pulse modulation reference signal, a triangular wave phase reference signal that prescribes a phase of a triangular wave signal.

3. The liquid jetting device according to claim 1,
wherein in the case where the pulse modulation of the drive waveform signal by the modulator is a pulse density modulation, the pulse modulation reference signal generating section outputs, as a pulse modulation reference signal, a reset signal that resets a modulation sequence or a modulation parameter.

4. A liquid jetting device comprising plural nozzles provided at a liquid jetting head, actuators provided in correspondence with the respective nozzles, and a drive section that applies a drive signal to each of the actuators of the nozzles from which liquid is to be jetted,
the liquid jetting device comprising:
a drive waveform generator that generates a drive waveform signal as a reference of a signal that controls a drive state of each of the actuators;
a modulator that performs a pulse modulation of the drive waveform signal which has been generated at the drive waveform generator;
a digital power amplifier that power-amplifies a modulated signal which has been caused to undergo a pulse modulation at the modulator; and
a low pass filter (LPF) that smoothes the amplified digital signal which has been power-amplified at the digital power amplifier to deliver the smoothed modulated signal thus obtained, as a drive signal to each of the actuators,
wherein in the case where the pulse modulation of the drive waveform signal by the modulator is a pulse width modulation, a period of the drive waveform signal is caused to be integral multiple of an operation period in the modulator.
